(19) United States
(12) Patent Application Publication
(10) Pub. No.: US 2008/0031009 A1
(43) Pub. Date: Feb. 7, 2008

(54) Light emitting apparatus

(75) Inventors: Hiroshi Kodaira, Kawachi-gun (JP); Mitsunori Ishizaka, Minamitsuru-gun (JP); Sadato Imai, Hachiouji-shi (JP)

Correspondence Address: BROWDY AND NEIMARK, P.L.L.C.;624 NINTH STREET, NW, SUITE 300, WASHINGTON, DC, 20001-5303, US

(73) Assignee: Citizen Electronics Co., LTD., Fujiyoshida-shi (JP)

(21) Appl. No.: 11/709,282

(22) Filed: Feb. 22, 2007

(30) Foreign Application Priority Data
Feb. 22, 2006 (JP) 2006-045302

(51) Int. Cl. F21V 7/04

(52) U.S. Cl. 362/612

(57) ABSTRACT

A light emitting apparatus including a board (2), at least one LED element (3) mounted on the board (2), a first resinous sealing member (4) to seal the LED element (3) and having a linear coefficient of expansion, and a second resinous sealing member (5) to cover the first resinous sealing member (4) and having a linear coefficient of expansion, the first resinous sealing member (4) containing a functional additive comprising at least one of a fluorescent material, an inorganic filler, and a diffusing agent, the linear coefficient of expansion of the first resinous sealing member (4) being set to be substantially identical with the linear coefficient of expansion of the second resinous sealing member (5).

### CROSS-REFERENCE TO THE RELATED APPLICATION

This application is based on and claims priority from Japanese Patent Application No. 2006-045302, filed on Feb. 22, 2006, the disclosure of which is incorporated herein by reference in its entirety.

### BACKGROUND OF THE INVENTION

1. Field of the Invention

The present invention relates to a light emitting apparatus suitable to, for example, as a supplementary light source to facilitate the capturing of moving images with a mobile phone, or as a light source for general lighting.

2. Description of Related Art

In recent years, white LED devices containing blue LED chips or ultra-violet LED chips have been used, for example, as a supplementary light sources to facilitate the capturing of moving images with mobile phones, as light sources for general lighting, and as light sources in the head light of vehicles, or the like.

Many of these white LED devices include a resinous sealing member to seal an LED chip and a resinous lens part provided on the sealing member and configured to collect light emitted from the LED chip. In such a white LED device, epoxy resin, acrylic resin, polycarbonate resin or the like are mainly used as materials for the lens part due to their transparency and good qualities of formability and workability.

Also, high-output types white LED devices are recently used for supplementary light sources or light sources for general lighting. To increase output, a higher current is applied to the LED chip thereby causing more internal heat generation of the LED device. Heat generated by applying a higher current and sunlight may deteriorate characteristics of the LED device over time.

Consequently, silicon resin resistant to heat or ultraviolet is used for sealing the LED chip.

Also, when the LED devices are subject to reflow process, there are cases in which cracks or peeling may occur at the interface between the resinous member sealing the LED chip and the lens part because of different coefficients of heat expansion of the sealing member and the lens part. Also, cracks may lead to breakdown; in particular, if a crack occurs in the sealing member, the Au (gold) wires connecting the LED chip to the circuit board may become disconnected.

Therefore, there has been proposed a high reliability light emitting device in which an LED chip is sealed by a soft resinous member, the soft resinous member is sealed by a hard resinous member and an overflow receiving part such as a concave is provided in the hard resinous member to ease any strain in the sealed state between the hard resinous member and the soft resinous member (for reference, see Japanese Patent Laid-Open No. 2004-363454, claims and FIG. 1).

There has also been proposed an LED lamp package in which an LED element is covered by a resinous buffer member which is made of silicon resin and covered by a translucent casing lid member, and which is provided with an overflow receiving part configured to receive any excess volume caused by different coefficients of heat expansion (for reference, see Japanese Patent Laid-Open No. 2005-116817, claims and FIG. 1).

In the above-mentioned light emitting devices, provision of the overflow absorption part as mentioned above allows relaxation of the stresses generated by the different heat expansion coefficients between the soft resinous member and the hard resinous member, or between the resinous buffer member and the translucent casing lid member.

However, each of the above-mentioned conventional light emitting devices suffer the problem that a space to provide the overflow absorption part must be secured, thereby limiting the freedom in design of the shape of the light emitting device and making miniaturization of the light emitting device difficult.

### SUMMARY OF THE INVENTION

An object of the present invention is to provide a light emitting apparatus in which peeling due to heat stress or the occurrence of cracks can be effectively prevented without limiting the freedom in shaping of the sealing member, board and so on.

To accomplish the above object, a light emitting apparatus according to one embodiment of the present invention includes a board, at least one light emitting diode element mounted on the board, a first resinous member to seal the light emitting diode element and having a linear coefficient of expansion, and a second resinous member to cover the first resinous sealing member and having a linear coefficient of expansion, respective linear coefficients of expansion of the first resinous sealing member and the second resinous sealing member being set to be substantially identical.

Because the first resinous sealing member and the second resinous sealing member have substantially the same linear coefficients of expansion, no difference in heat expansion occurs between the first and second resinous sealing members so that heat expansion homologates and stress caused by heat is reduced, therefore it is possible to prevent peeling or cracking irrespective of a shape of the first and second resinous sealing members.

In one embodiment, the first resinous sealing member contains a functional additive which comprises, for example, at least one of a fluorescent material, inorganic filler and diffusing agent. It is possible to achieve fine adjustment of the linear coefficient of expansion of the first resinous sealing member by including the inorganic filler therein.

In addition, the first resinous sealing member is preferably made of a soft resin having a degree of hardness lower than that of the second resinous sealing member.

### BRIEF DESCRIPTION OF THE DRAWINGS

FIG. 1A is a perspective view showing a light emitting apparatus according to a first embodiment of the present invention.

FIG. 1B is a sectional view taken along the A1-A1 line in FIG. 1A.

FIG. 1C is a sectional view taken along the B1-B1 line in FIG. 1A.

FIG. 2A is a perspective view showing a light emitting apparatus according to a second embodiment of the present invention.

FIG. 2B is a sectional view taken along the A2-A2 line in FIG. 2A.

FIG. 2C is a sectional view taken along the B2-B2 line in FIG. 2A.

FIG. 3A is a perspective view showing a light emitting apparatus according to a third embodiment of the present invention.

FIG. 3B is a sectional view taken along the A3-A3 line in FIG. 3A.

FIG. 3C is a sectional view taken along the B3-B3 line in FIG. 3A.

### DETAILED DESCRIPTION OF THE PREFERRED EMBODIMENTS

Preferred embodiments of the present invention will be explained in detail with reference to the accompanying drawings below.

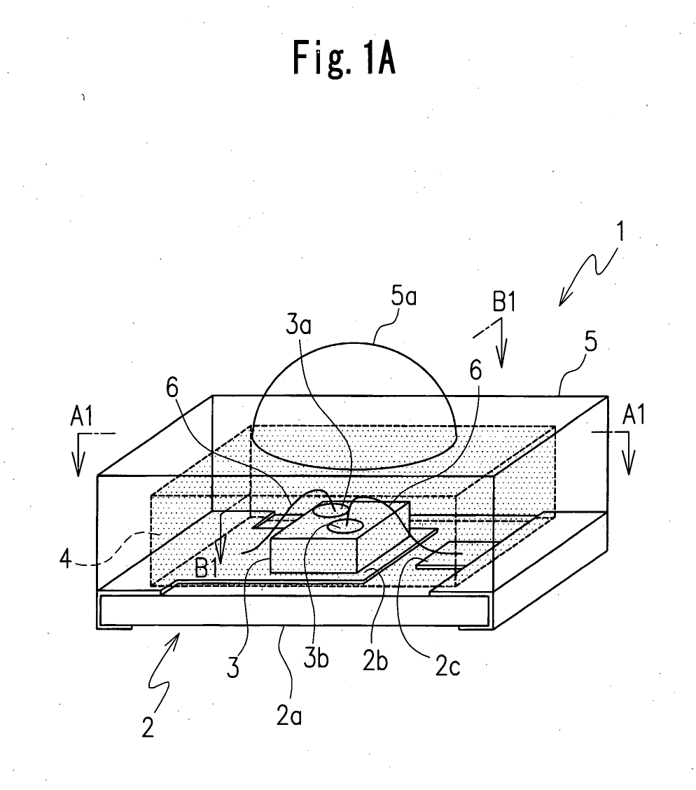

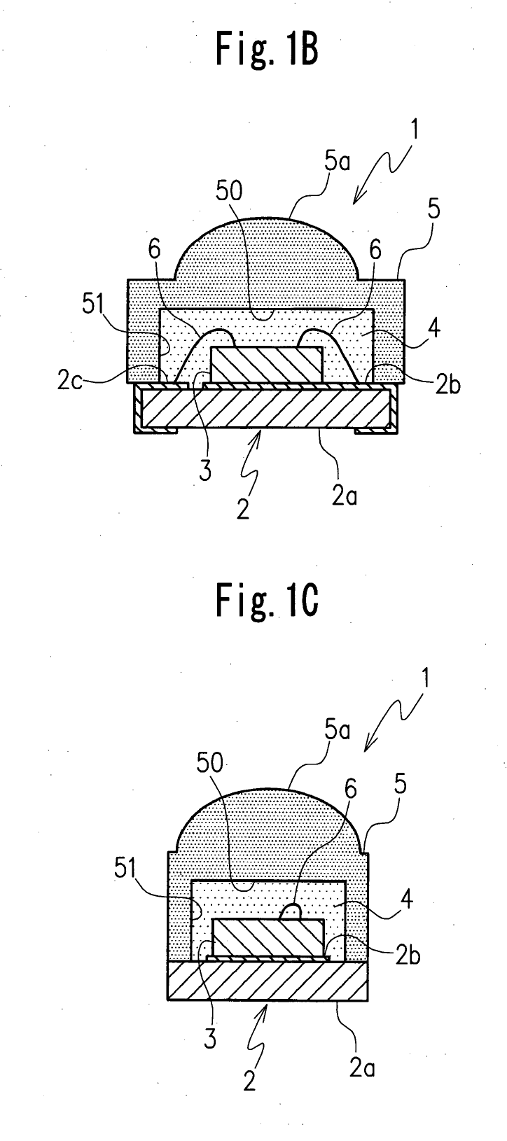

FIGS. 1A, 1B and 1C show a first embodiment of a light emitting apparatus according to the present invention.

The light emitting apparatus 1 in the first embodiment is applied to a white LED device which is used, for example, as a supplementary light source to facilitate the capturing of a moving image with a mobile phone or as a light source for general lighting. However, the light emitting apparatus according to the present invention can be applied to devices other than the white LED device.

The light emitting apparatus 1 includes a board or circuit board 2, at least one LED element 3 mounted on one surface, for example, an upper surface of the circuit board 2, a first resinous sealing member 4 to seal the LED element 3 and a second resinous sealing member 5 to cover the first resinous sealing member 4.

The circuit board 2 includes a main body 2a having a generally rectangular solid-like shape, and an anode electrode pattern 2b and a cathode electrode pattern 2c which are patterned in a predetermined shape onto, for example, the upper surface of the main body 2a.

The anode electrode pattern 2b is disposed at one end of the main body 2a and extends from a central portion of the main body 2a passing around the one end of the main body to a lower surface of the main body 2a. The cathode electrode pattern 2c is disposed at an opposite end of the main body 2a to face the anode electrode pattern 2b and extends from a position close to the opposite end of the main body 2a passing around the opposite end to the lower surface of the main body 2a.

The main body 2a is formed by, for example, an insulative board such as a glass epoxy board, a BT (bismaleimide triazine) resinous board, a ceramic board, a metal cored board, or the like.

In this embodiment, the LED element 3 is made of a blue (wavelength λ: 470 to 490 nm) LED formed by, for example, a gallium nitride-type compound semiconductor or silicon carbide-type compound semiconductor, or ultraviolet (wavelength λ: less than 470 nm) LED.

The LED element 3 includes a main emission surface provided on an upper surface thereof, and a (p) side electrode 3a and an (n) side electrode 3b which are provided on the main emission surface. The LED element 3 has a structure in which a plurality of InGaN-type-compound semiconductor layers are crystal-grown onto, for example, an insulative board such as a sapphire board or the like.

The LED element 3 is disposed on the anode electrode pattern 2b at the generally central portion of the upper surface of the main body 2a of the circuit board 2 and secured through, for example, an adhesive (not shown) to the anode electrode pattern 2b. A resinous insulative adhesive or the like such as epoxy resin or silicon resin, or a conductive adhesive or the like such as soldering agent or Ag paste or the like can, for example, be used as the adhesive.

The above-mentioned p side electrode 3a is electrically connected to the anode electrode pattern 2b through an Au wire 6, and the n side electrode 3b is electrically connected to the cathode electrode pattern 2c through another Au wire 6. The p and n side electrodes 3a and 3b may be electrically connected to the anode and cathode electrode patterns 2b and 2c, respectively by other connection methods different from the above.

In this embodiment, the first and second resinous sealing members 4 and 5 are together made of, for example, a translucent silicon resin.

Here, it should be noted that the first resinous sealing member 4 is made of a soft silicon resin having a degree of hardness lower than that of the second resinous sealing member 5, and the second resinous sealing member 5 is made of a hard silicon resin having a high degree of hardness.

With such a structure, the LED element 3 of relatively small size can be covered by the soft first resinous sealing member 4, and the whole of the first resinous sealing member 4 and the LED element 3 can be securely covered by the hard second resinous sealing member 5.

It should also be noted here that the linear coefficient of expansion of the first resinous sealing member 4 is set to be substantially identical with the linear coefficient of expansion of the second resinous sealing member 5.

With such a structure, no difference in heat expansion arises between the first and second resinous sealing members 4 and 5 so that the same heat expansion is maintained between the first and second resinous sealing members 4 and 5, and the occurrence of any heat stress between the first and second resinous sealing members 4 and 5 is thereby effectively prevented.

The first resinous sealing member 4 contains a functional additive which comprises, for example, at least one of a fluorescent material, an inorganic filler and a diffusing agent, or a mixture of any two or three of the fluorescent material, the inorganic filler and the diffusing agent.

The fluorescent material is, for example, YAG (yttrium aluminum garnet) fluorescent material which converts blue light or ultraviolet light emitted from the LED element 3 into white light. The inorganic filler comprises, for example, at least one of silicon dioxide (silica), boron nitride, calcium phosphate, a rare earth compound or the like or a mixture thereof. By mixing the inorganic filler in the first resinous sealing member 4, fine adjustment of the linear coefficient of expansion of the first resinous sealing member 4 relative to that of the second resinous sealing member 5 can be achieved. Furthermore, aluminum dioxide, titanic dioxide, silicon dioxide or the like are used as the diffusing agent. By mixing the diffusing agent in the first resinous sealing member 4, it is possible to emit a more uniform emission color from the light emitting apparatus 1.

It should be noted that, in the above-mentioned embodiment, because the first and second resinous sealing members 4 and 5 are together made of the silicon resin, the linear coefficient of expansion of the first resinous sealing member 4 is approximately the same as that of the second resinous sealing member 5. However, if the linear coefficient of expansion of the first resinous sealing member 4 is different from that of the second resinous sealing member 5 due to a difference in the degree of hardness between the first and second resinous sealing members 4 and 5, the linear coefficients of expansion of the first and second resinous sealing members 4 and 5 may be controlled to be similar to each other by adjusting the amount of the above-mentioned inorganic filler or the like which is added.

The above-mentioned second resinous sealing member 5 includes a concave portion 50 which is provided in an inside of a lower surface thereof and configured to contain the LED element 3 and the first resinous sealing member 4 therein. Accordingly, when the second resinous sealing member 5 is attached to the circuit board 2, a containing space 51 to contain the LED element 3 and the first resinous sealing member 4 therein is formed between the circuit board 2 and the second resinous sealing member 5. The first resinous sealing member 4 can be formed by injecting a liquid silicon resin which is the material of the first resinous sealing member 4 into the containing space 51 and hardening it.

More specifically, the first resinous sealing member 4 can be formed by injecting the liquid silicon resin containing the functional additive into the containing space 51 through an injection hole (not shown) which is provided in the circuit board 2 or the like and communicates with the containing space 51 and hardening the injected silicon resin to a predetermined degree of hardness which is softer than that of the second resinous sealing member 5 through heat processing, after the second resinous sealing member 5 is secured to the circuit board 2 by, for example, an adhesive (not shown).

Meanwhile, if a plurality of light emitting apparatuses 1 are produced simultaneously, at least one injection hole is provided in the circuit board 2 or the second resinous sealing member 5 corresponding to each LED element 3. Therefore, because the first resinous sealing member 4 is completely divided into small portions for each LED element 3, there is the advantageous effect that variations in distribution of the fluorescent material in the first resinous sealing member 4 can be reduced.

The second resinous sealing member 5 has a collecting lens part 5a at an upper surface thereof. The collecting lens part 5a is formed as a convex lens which is disposed to face the LED element 3 and configured to focus light emitted from the LED element 3.

In this embodiment, because the first and second resinous sealing members 4 and 5 are set to have substantially the same linear coefficient of expansion, no difference in heat expansion occurs between the first and second resinous sealing members 4 and 5 so that the heat expansion homologates, and the generation of heat stress throughout the first and second resinous sealing members 4 and 5 is thereby reduced.

Because the first resinous sealing member 4 contains the functional additive, the generation of heat stress can be further restrained. Accordingly, it is possible to achieve a highly flexible shape design for the light emitting apparatus and prevent the occurrence of peeling or cracking, regardless of the shape of the first and second resinous sealing members 4 and 5, the circuit board 2, and so on.

Moreover, because the first resinous sealing member 4 is made of a resin softer than that of the second resinous sealing member 5, a small stress is exerted on the LED element 3, the Au wires 6 and so on; conversely, because the second resinous sealing member 5 is made of a hard resin, it is possible to achieve high strength with respect to external forces and thus obtain high reliability.

Furthermore, because the collecting lens part 6a is formed on the upper surface of the second resinous sealing member 5 which is harder than the first resinous sealing member 4, it has a high mechanical strength and high accuracy which makes it possible to obtain a high focusing effect. In particular, because the fluorescent material and the diffusing agent are mixed in the first resinous sealing member 4, the light emitted from the LED element 3 is wavelength-converted by the first resinous sealing member 4 containing the fluorescent material and the diffusing agent to generate emission color, and the wavelength-converted emission color is uniformized and focused by the collecting lens part 6a, allowing a high brightness emission to be achieved.

In the above-mentioned embodiment, because both the first and second resinous sealing members 4 and 5 are formed by the same silicon resin, it is easy to set their linear coefficients of expansion to be similar to each other, improved adhesiveness of the first and second resinous sealing members 4 and 5 can be achieved, and they can thereby be prevented from peeling. In addition, because the first and second resinous sealing members 4 and 5 are formed by the silicon resin which has resistance to heat and ultraviolet rays, high heat resistance and high light resistance can be secured.

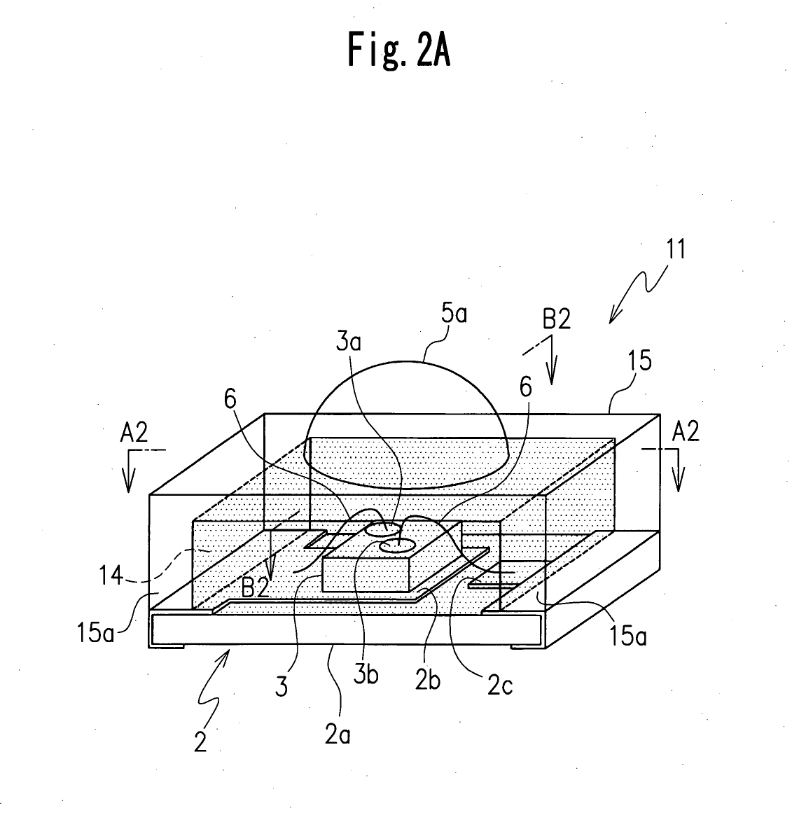

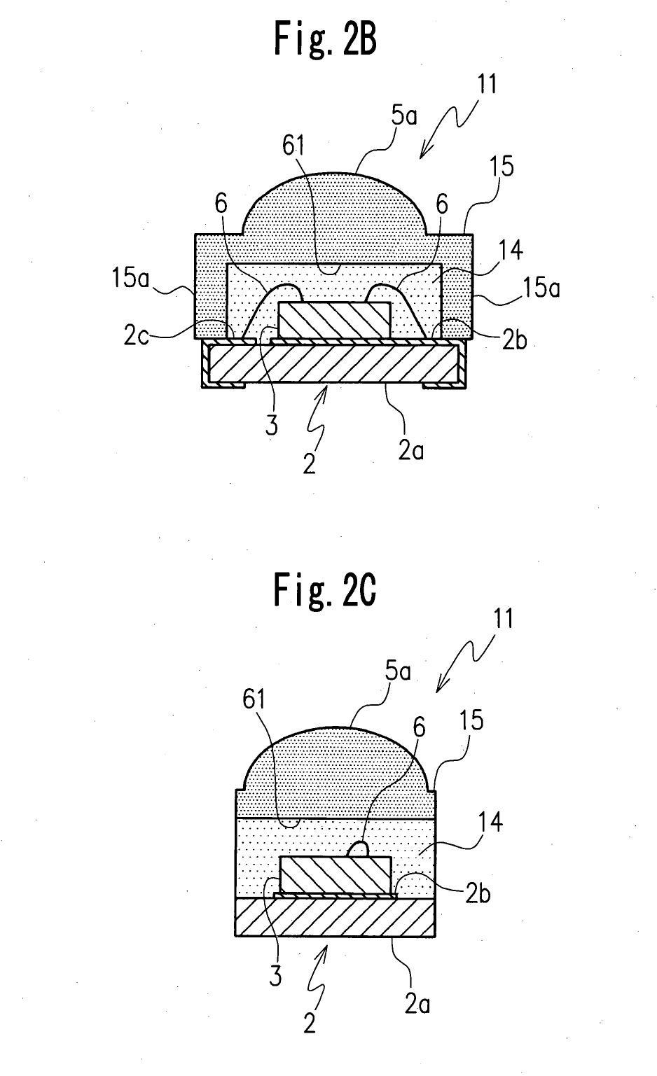

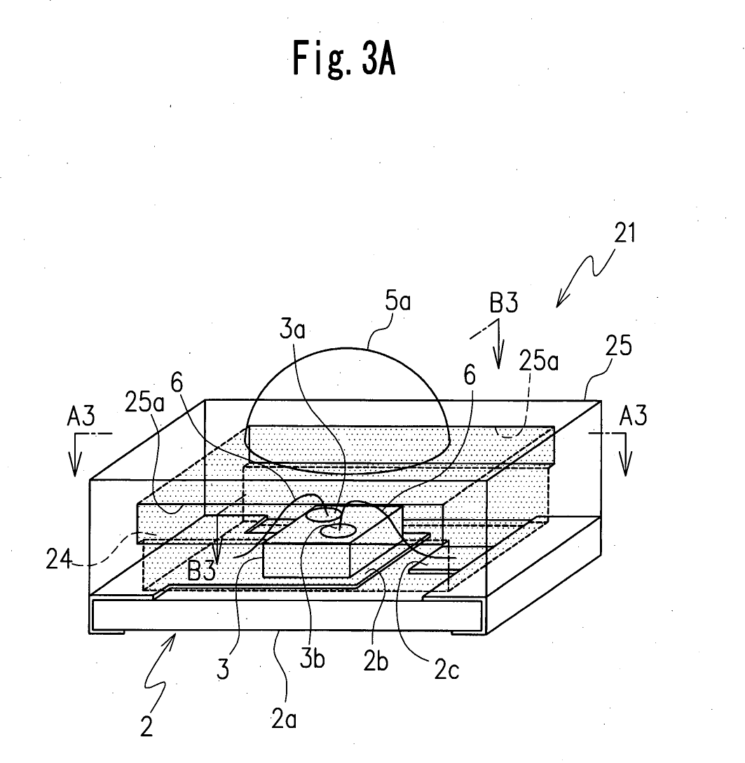

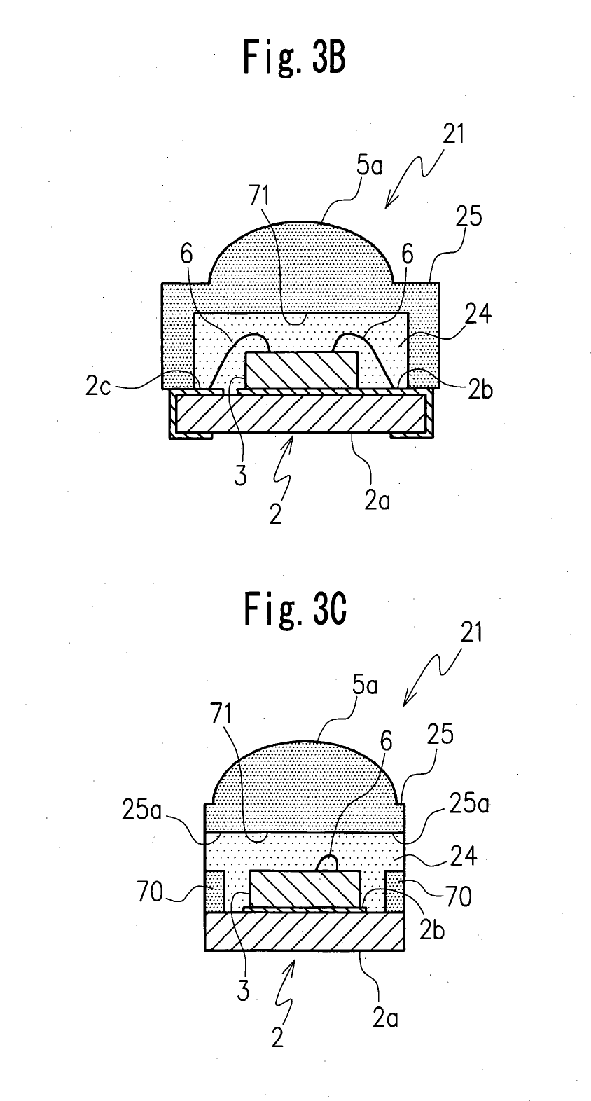

Next, a second embodiment and a third embodiment of the light emitting apparatus according to the present invention are explained with reference to FIGS. 2A, 2B, 2C, and 3A, 3B, 3C, respectively.

It should be noted that, in the following explanations of the second and third embodiments, identical reference numbers are attached to parts which are similar to those in the above-mentioned first embodiment and a further description thereof is omitted.

A light emitting apparatus 11 as shown in the second embodiment differs from the light emitting apparatus 1 shown in the first embodiment in that a first resinous sealing member 14 is not covered completely by a second resinous sealing member 15.

More specifically, in the light emitting apparatus 1 shown in the first embodiment, the first resinous sealing member 4 is completely covered by the second resinous sealing member 5. In contrast, in the light emitting apparatus 11 shown in the second embodiment, the first resinous sealing member 14 is exposed from the second resinous sealing member 15 at both sides of the second resinous sealing member 15 where the anode electrode pattern 2b and the cathode electrode pattern 2c are not disposed (see FIGS. 1C and 2C).

In other words, in the light emitting apparatus 11 shown in the second embodiment, the second resinous sealing member 15 includes a pair of supporters 16a which are provided on both sides where the anode electrode pattern 2b and the cathode electrode pattern 2c are disposed and adhered to the circuit board 2 (see FIG. 2B).

Consequently, a concave portion 61 to contain the first resinous sealing member 14 is formed between the pair of supporters 16a. The pair of supporters 16a extend from both sides of the second resinous sealing member 15 to fringes of the circuit board 2.

The first resinous sealing member 14 is exposed from the second resinous sealing member 15 at sides except the pair of supporters 16a being disposed.

In this second embodiment, when a plurality of light emitting apparatuses 11 are produced simultaneously, LED element 3 is mounted one- or two-dimensionally on each of the circuit boards 2, because the concave portions adjacent to each other are in communication at both sides of the second resinous sealing member 15 except the pair of supporters 16a being disposed. Liquid silicon may be injected from one side of a concave portion to fill a plurality of concave portions at every array of the communicating adjacent concave portions when a plurality of light emitting apparatuses are manufactured as an aggregation.

A light emitting apparatus 21 shown in the third embodiment differs from the light emitting apparatus 11 shown in the second embodiment in the exposed portion of the first resinous sealing member 24.

More specifically, the first resinous sealing member 24 is exposed at sides except the pair of supporters 16a being disposed. In the light emitting apparatus 21 shown in the third embodiment, the first resinous sealing member 24 is exposed at upper portion of sides except the pair of supporters 16a being disposed (see FIG. 3C).

In other words, in the light emitting apparatus 21 shown in the third embodiment, the second resinous sealing member 25 includes a window 25a which is provided at each of both sides of the second resinous sealing member 25 where the anode electrode pattern 2b and the cathode electrode pattern 2c are not disposed and is configured to open about half of a thickness of the second resinous sealing member 25, as shown in FIG. 3C.

The LED element 3 is sealed in a state in which the first resinous sealing member 24 is filled in a concave portion 71 surrounded by the circuit board 2 and the second resinous sealing member 25.

In the third embodiment, similarly to the second embodiment, when a plurality of light emitting apparatuses 21 are produced simultaneously, a substrate assembly including a plurality of the circuit boards 2 is arranged in a matrix in a plane on which at least one LED elements 3 is mounted on each of the circuit boards 2. In this case, because the concave portions for LED elements adjacent to each other are in communication at both sides except the pair of supporters being disposed. Liquid silicon may be injected from an injection hole-provided for every array of the communicating adjacent containing spaces 71, thus, liquid silicon resin can be injected at the same time into all the concave portions in the array to allow sealing of each LED element 3.

Meanwhile, in the third embodiment, because the second resinous sealing member 25 includes a frame-like partition wall 70 which is provided at a lower end thereof and at each of both sides of the second resinous sealing member 25 where the anode electrode pattern 2b and the cathode electrode pattern 2c are not disposed (see FIG. 3C), settlement of the fluorescent material or the like which is contained in the first resinous sealing member 24 in the concave portion is limited by the partition walls disposed at the lower end of the second resinous sealing member 25, thereby variation in distribution of the fluorescent material can be reduced more than in the second embodiment.

In the above-mentioned second and third embodiments, if one injection path linking the arrays of the containing spaces 61 and 71 is provided, the liquid silicon resin can be simultaneously injected into all the containing spaces 61 and 71 in its entirety only by the one injection path. Alternatively, if an injection hole is provided in each LED element 3, it is possible to reduce variation in distribution of the fluorescent material in each of the light emitting apparatuses 11 and 21.

It should be noted that the present invention is not limited to the above-mentioned embodiments. For example, as in each of the above-mentioned embodiments, the present invention has been suitably applied to the white LED device in which fluorescent material is contained in each of the first resinous sealing members 4, 14 and 24 and the LED element 3 for emitting blue light or ultraviolet light to obtain white light is used, but may be applied to an LED device configured to emit infrared, red, or green light in which an LED element for emitting light in other ranges of wavelength such as infrared, red or green light or the like is used.

Moreover although it is preferable to use the second resinous sealing members 5, 15 and 25 each having the collecting lens part 5a, as mentioned above, a second resinous sealing member having a flat upper surface with no collecting lens part 5a may be substituted for these.

In addition, as mentioned above, the first resinous sealing members 4, 14, 24 and the second resinous sealing members 5, 15, 25 are each preferably made of silicon resin, but they may also be made of other similar materials or different materials as long as the same or similar linear coefficient of expansion is set. For example, epoxy resin, polyamide resin, acrylic resin, polycarbonate resin or the like may preferably be selected as materials of the first and second resinous sealing members.

According to the present invention, because the first resinous sealing member contains the functional additive and has the same or similar linear coefficient of expansion as or to the second resinous sealing member, no difference in heat expansion occurs between the first and second resinous sealing members and the generation of heat stress is reduced, so that peeling and cracking can be prevented from occurring in the first and second resinous sealing members, regardless of the shape of the first and second resinous sealing members and so on. In particular, because the first and second resinous sealing members are formed by the silicon resin resistant to heat and ultraviolet rays, it is possible to achieve a light emitting apparatus with high heat-resistance, high light-resistance and high reliability.

In addition, because the first and second resinous sealing members in the light emitting apparatus have the same linear coefficient of expansion, heat expansion between the first and second resinous sealing members homologates to reduce the generation of heat stress, thus preventing peeling and cracking.

Moreover, the light emitting apparatus according to the present invention is characterized in that the functional additive is at least one of the fluorescent material, the inorganic filler and the diffusing agent. In other words, by mixing the fluorescent material as the functional additive in the first resinous sealing member in the light emitting apparatus, it is possible to convert the wavelength of light emitted from the LED element into another wavelength to emit another emission color.

Also, by mixing the inorganic filler as the functional additive in the first resinous sealing member, fine adjustment of the linear coefficients of expansion can be achieved, thus enabling more accurate equalization of the linear coefficients of expansion of the first and second resinous sealing members. In addition, mixing the diffusing agent as the functional additive in the first resinous sealing member is advantageous since it allows more uniform emission color to be achieved.

As mentioned above, because the same linear coefficient of expansion is maintained for the first and second resinous sealing members even in the state where the first resinous sealing member contains any of the fluorescent material, the inorganic filler and the diffusing agent, the above-mentioned advantageous effects can be achieved in addition to the prevention of heat stress.

In the light emitting apparatus according to the present invention, the first resinous sealing member is made of a resin softer than that of the second resinous sealing member. That is to say, in this light emitting apparatus, because the first resinous sealing member is made of a resin softer than that of the second resinous sealing member, a small stress is exerted on the LED element, the Au wires and so on; conversely, because the second resinous sealing member is made of a hard resin, it is possible to achieve high strength with respect to external forces and thus obtain high reliability.

Moreover, the light emitting apparatus according to the present invention is characterized in that the collecting lens part is provided on the upper surface of the second resinous sealing member. In other words, because the collecting lens part in the light emitting apparatus is provided on the upper surface of the second resinous sealing member which is harder than the first resinous sealing member, it has a high mechanical strength and high accuracy which makes it possible to obtain a high focusing effect. In particular, if the fluorescent material and the diffusing agent are mixed in the first resinous sealing member, the wavelength-converted emission color get uniform and focused, allowing a high brightness emission to be achieved.

The light emitting apparatus according to the present invention is characterized in that the first and second resinous sealing members are made of silicon resin. That is to say, because both the first and second resinous sealing members in the light emitting apparatus are made of the same or similar silicon resin, the linear expansion coefficients thereof are easy to match and improved adhesion between the first and second resinous sealing members can be achieved, thus allowing effective prevention of peeling of the first and second resinous sealing members or the like. In addition, because the first and second resinous sealing members are made of silicon resin which is resistant to heat and ultraviolet rays, the light emitting apparatus has high heat-resistance and high light-resistance.

Furthermore, in the light emitting apparatus according to the present invention, the LED element emits blue or ultraviolet, and the functional additive is the fluorescent material to convert the blue or ultraviolet light into white light. That is to say, the light emitting apparatus makes possible the formation of a white LED device having high reliability with regards to heat stress.

Although the preferred embodiments of the present invention have been mentioned, it should be noted that the present invention is not limited to these embodiments, and various modifications, variations and changes can be made to the embodiments.

1. A light emitting apparatus, comprising:
a board;
at least one light emitting diode element mounted on the board;
a first resinous sealing member sealing the light emitting diode element and
a second resinous sealing member covering the first resinous sealing member,
respective linear coefficients of expansion of the first resinous member and the second resinous sealing member being set to be substantially identical.

2. The light emitting apparatus according to claim 1, wherein at least one functional additive is contained in the first resinous sealing member.

3. The light emitting apparatus according to claim 2, wherein the functional additive comprises at least one selected from among at least one fluorescent material, at least one inorganic filler and at least one diffusing agent.

4. The light emitting apparatus according to claim 2, wherein the first resinous sealing member contains at least one inorganic filler to enable a fine adjustment of the linear coefficient of expansion.

5. The light emitting apparatus according to claim 1, wherein the first resinous sealing member is made from resin softer than that of the second resinous sealing member.

6. The light emitting apparatus according to claim 1, wherein the first resinous sealing member which is a liquid resin is filled in a space formed by the board and the second resinous sealing member.

7. The light emitting apparatus according to claim 1, wherein the second resinous sealing member includes a collecting lens part disposed to face the light emitting diode element.

8. The light emitting apparatus according to claim 1, wherein the first resinous sealing member and the second resinous sealing member are made from silicon resin.

9. The light emitting apparatus according to claim 2, wherein the light emitting diode element is configured to emit blue light or ultraviolet light,
wherein the at least one functional additive is a fluorescent material to convert the blue light or ultraviolet light into white light.

10. The light emitting apparatus according to claim 1, wherein at least one injection hole to mold the first resinous sealing member is provided in one selected from the second resinous sealing member or the board.
